(19) United States
(12) Patent Application Publication
(10) Pub. No.: US 2006/0206375 A1
(43) Pub. Date: Sep. 14, 2006

(54) System and method for targeted advertising and promotions based on previous event participation

(75) Inventors: Deborah Scott, Pleasant Hill, CA (US); John Delaplaine, Kenwood, CA (US)

Correspondence Address: Starkweather and Associates, Suite 200, 9035 South 1300 East, Sandy, UT, 84094, US

(73) Assignee: Light Rhythms, LLC

(21) Appl. No.: 11/078,783

(22) Filed: Mar. 11, 2005

(51) Int. Cl. G06Q 30/00

(52) U.S. Cl. 705/14

(57) ABSTRACT

A novel information gathering and dissemination method includes: a) providing a portable light emission device carried by a user, and activated according to a remotely received signal, so that the light of the device acts as a pixel of a remotely generated display; b) assigning, a unique identifier; c) recording event history information d) coupling the device via a link to a computer; e) connecting the computer to an Internet website; f) establishing a personal data page pertaining to a unique device and recording in the personal data page, user biographical and personal information uploaded by a user, and storing event history information; g) based upon information from the personal data page, predicting communications likely to be of interest to the user; and h) forwarding to the user, communications predicted to be of interest to the user.

### FIELD OF THE INVENTION

The present invention relates to advertising and promotions targeted to likely consumers—specifically through electronic means.

### DESCRIPTION OF THE RELATED ART

U.S. patent application Ser. No. 10/985,399, filed Nov. 9, 2004 for “Apparatus, System and Method for Controlling Remote Lighting Devices,” discloses a method for enhancing the experience of audience members at concerts, sporting events, and the like.

In the aforementioned patent application, audience members are provided with special hardware devices that nominally include light emitters, receivers for receiving transmitted signals for activating the light emitters, and means for recording the participation in events, as well as the actions of the device during the events.

A master transmitter (or group of transmitters in the alternative), sends light activation signals throughout the event viewing area accompanied by the addresses H of individual light emission devices, or groups of devices to which the light activation signals pertain. In essence, each light emission device represents a pixel associated with an individual user that can be turned on or off as part of a large display encompassing the light emission devices (and hence, the audience members).

Effective advertising has become increasingly more challenging, as prospective consumers are deluged with undesirable communications, and such consumers have become more predisposed to ignore communications as a result. The participation at events utilizing devices disclosed in the aforementioned U.S. patent application may be excellent targets for certain advertising based on their known, previous behavior:

What are therefore of great interest, but undeveloped, are approaches to entice consumer-participants at such events to provide information useful to advertising, so that targeted advertising and promotions likely to be taken seriously, can be sent to said consumer-participants.

### SUMMARY OF THE INVENTION

The present invention has been developed in response to the present state of the art, and in particular, in response to the problems and needs in the art that have not yet been fully solved by currently available liner supports. Accordingly, the present invention has been developed to provide an information gathering and information dissemination method that at least includes: a) providing a portable light emission device adapted to be carried by a user, and adapted to be activated according to a remotely received signal, so that the light of the device acts as a pixel of a remotely generated display; b) assigning to the device, a unique identifier; c) recording event history information at least including the presence of the device at one or more predefined events; d) coupling the device via a link to a computer; e) connecting the computer to an Internet website; f) establishing a personal data page pertaining to a unique device and recording in the personal data page, user biographical and personal information uploaded by a user, and storing event history information; g) based upon information from the personal data page, predicting communications likely to be of interest to the user; and h) forwarding to the user, communications predicted to be of interest to the user.

The present invention has also been developed to provide an information gathering and information dissemination method that at least includes: a) providing a portable light emission device adapted to be carried by a user, and adapted to be activated according to a remotely received signal, so that the light of the device acts as a pixel of a remotely generated display; b) assigning to the device, a unique identifier; c) recording event history information at least including the presence of the device at one or more predefined events; d) coupling the device via a link to a computer; e) connecting the computer to an Internet website; f) establishing a personal data page pertaining to a unique device and recording in the personal data page, user biographical and personal information uploaded by a user, and storing event history information; g) based upon information from the personal data page, predicting communications likely to be of interest to the user; h) forwarding to the user, communications predicted to be of interest to the user; i) entering a user who has established or revisited a personal data page, into a contest to entice the user's cooperation in providing biographical and personal information; j) providing the results of the contest to the user; and k) providing a mechanism for a prize winning user to claim a prize.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates a schematic diagram of a system constructed according to the present-inventive information gathering and information dissemination method;

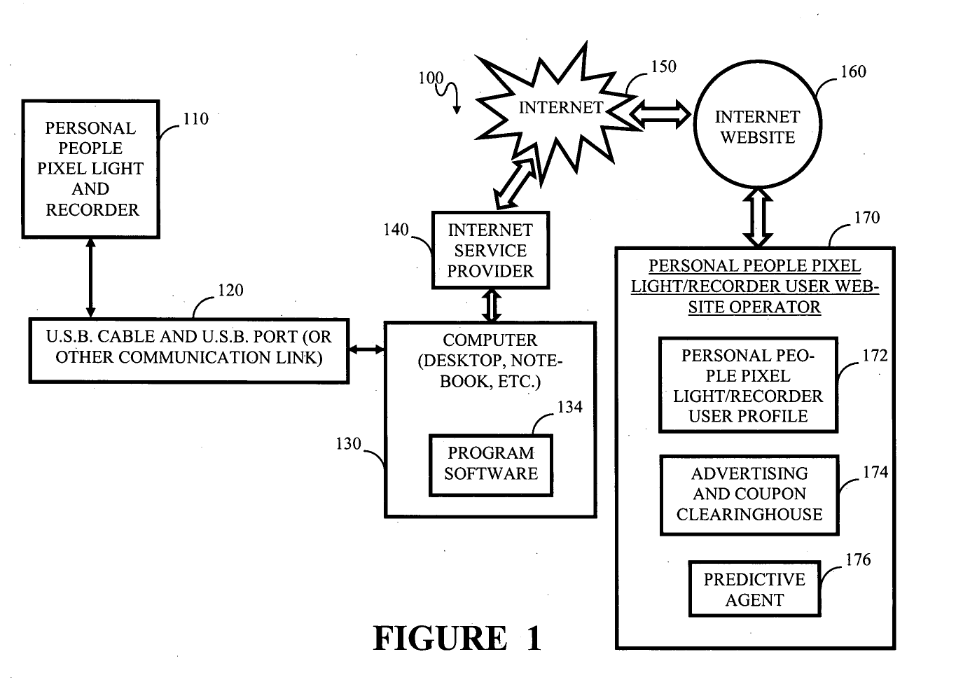

FIG. 2 illustrates a flowchart detailing the general steps in the present-inventive information gathering and information dissemination method;

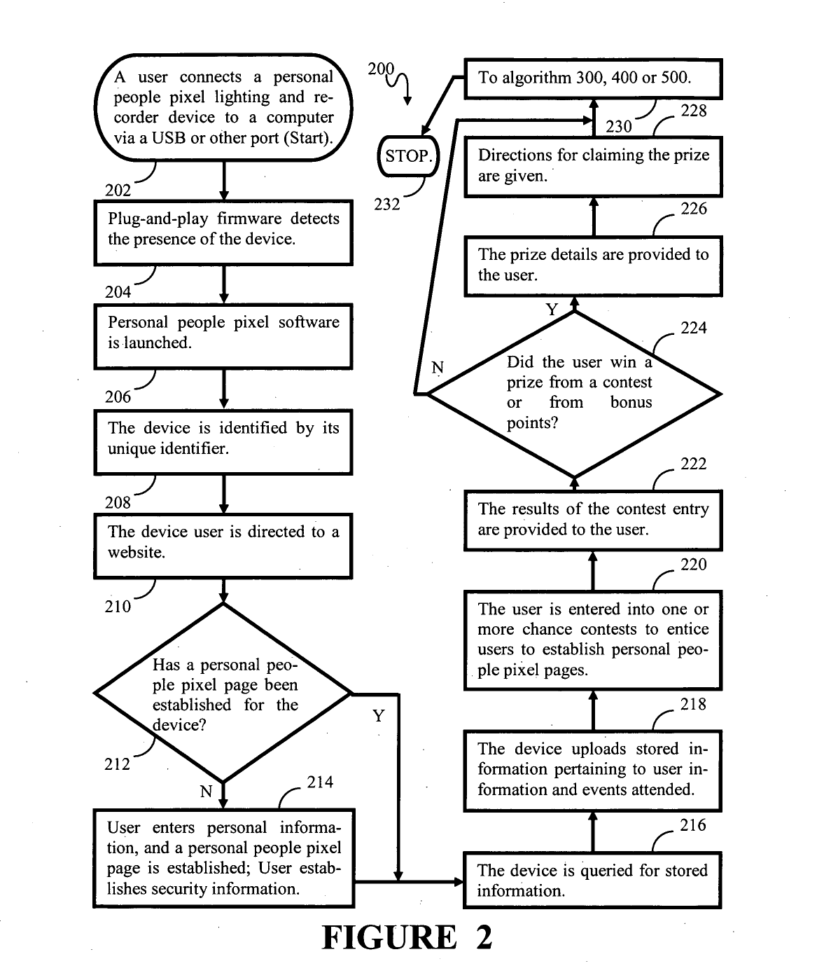

FIG. 3 illustrates a flowchart detailing specific steps in the present-inventive information gathering and information dissemination method related to subscribing merchants predicting and sending communications likely to be of interest to prospective consumers;

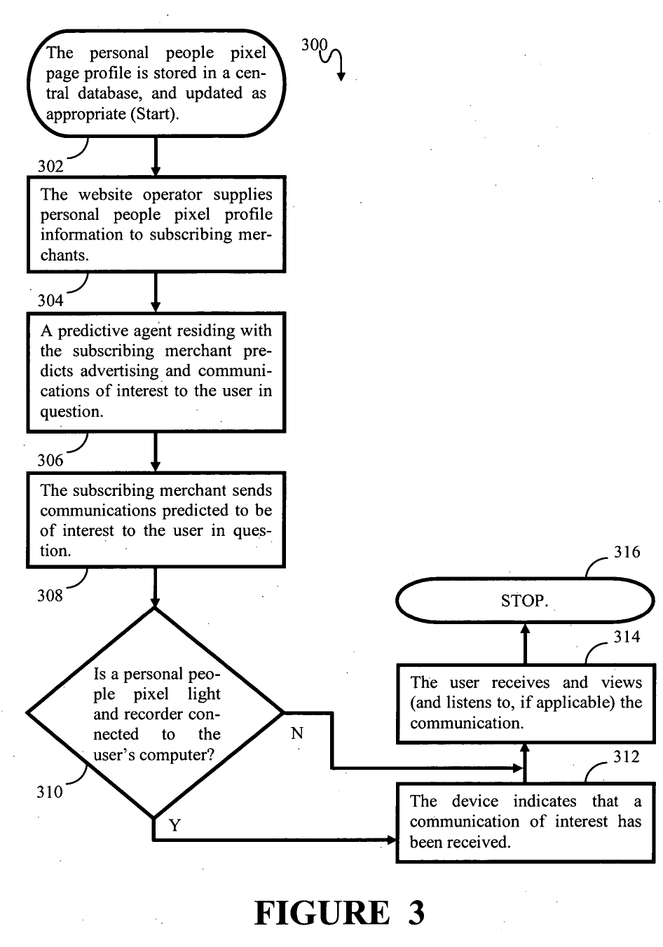

FIG. 4 illustrates a flowchart detailing specific steps in the present-inventive information gathering and information dissemination method related to website operators predicting communications likely to be of interest to prospective consumers, and subscribing merchants sending the predicted communications to the prospective consumers, as will be described infra.; and

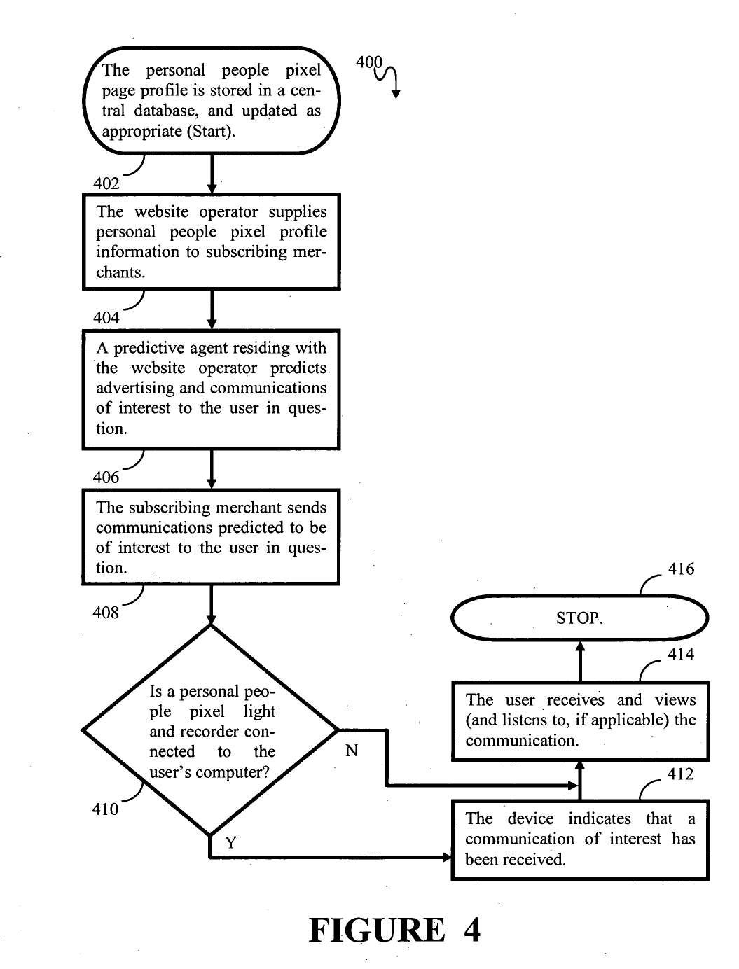

FIG. 5 illustrates a flowchart detailing specific steps in the present-inventive information gathering and information dissemination method related to website operators both predicting communications likely to be of interest to prospective consumers, and sending the predicted communications to the prospective consumers, as directed by subscribing merchants.

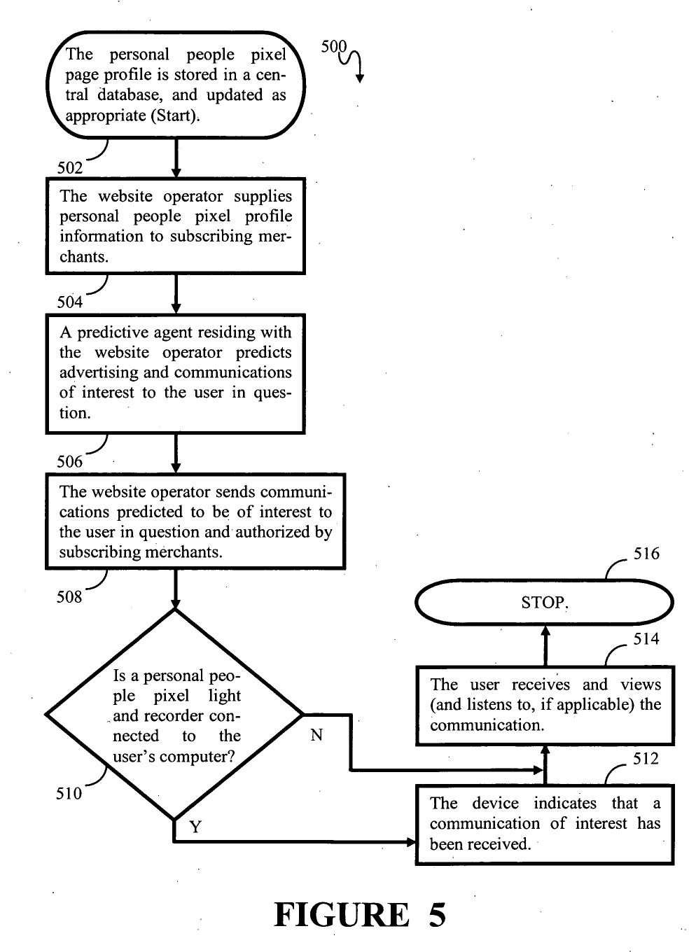

What is claimed is:

1. An information gathering and information dissemination method comprising:
a) providing a portable light emission device adapted to be carried by a user, and adapted to be activated according to a remotely received signal, so that the light of said device acts as a pixel of a remotely generated display;
b) assigning to said device, a unique identifier;
c) recording event history information comprising the presence of said device at one or more predefined events;
d) coupling said device via a link to a computer;
e) connecting said computer to an Internet website;
f) establishing a personal data page pertaining to a unique device and recording in said personal data page, user biographical and personal information uploaded by a user, and storing event history information;
g) based upon information from said personal data page, predicting communications likely to be of interest to said user; and
h) forwarding to said user, communications predicted to be of interest to said user.

2. The method of claim 1, further comprising:
entering a user who has established or revisited a personal data page, into a contest to entice the user's cooperation in providing biographical and personal information;
providing the results of said contest to said user; and
providing a mechanism for a prize winning user to claim a prize.

3. The method of claim 1, further comprising:
assigning predefined bonus points for events attended by a user;
tallying bonus points; and
providing a user with a prize when said bonus points reach a threshold level.

4. The method of claim 1, further comprising:
recording activities of said device at predefined events; and
wherein said predicting in element g) further comprises considering recorded activities of said device at predefined events.

5. The method of claim 1, wherein element c) is carried out via memory subsumed by said device.

6. The method of claim 1, wherein element c) is carried out via memory associated with at least one transmitter adapted to transmit said remotely received signal.

7. The method of claim 1, wherein said unique identifier comprises an electronic serial number (ESN).

8. The method of claim 1, further comprising:
sending a receipt signal to said user indicating that a communication intended for said user has been received.

9. The method of claim 1, further comprising:
sending a receipt signal to said user indicating that a communication intended for said user has been received; and
in response to said receipt signal, generating a user perceivable signal by a portable light emission device coupled to said computer.

10. The method of claim 1, wherein said communication is an advertisement.

11. The method of claim 1, wherein said communication contains a mechanism for providing a discount to the purchase of merchandise.

12. The method of claim 1, wherein said communication contains a mechanism for providing a discount to the purchase of services.

13. The method of claim 1, wherein said link comprises a USB port and USB cable.

14. The method of claim 1, wherein said link comprises a USB port and a wireless communication link.

15. The method of claim 1, wherein said link comprises a wireless communication link.

16. An information gathering and information dissemination method comprising:
a) providing a portable light emission device adapted to be carried by a user, and adapted to be activated according to a remotely received signal, so that the light of said device acts as a pixel of a remotely generated display;
b) assigning to said device, a unique identifier;
c) recording event history information comprising the presence of said device at one or more predefined events;
d) coupling said device via a link to a computer;
e) connecting said computer to an Internet website;
f) establishing a personal data page pertaining to a unique device and recording in said personal data page, user biographical and personal information uploaded by a user, and storing event history information;
g) based upon information from said personal data page, predicting communications likely to be of interest to said user;
h) forwarding to said user, communications predicted to be of interest to said user;
i) entering a user who has established or revisited a personal data page, into a contest to entice the user's cooperation in providing biographical and personal information;
j) providing the results of said contest to said user; and
k) providing a mechanism for a prize winning user to claim a prize.

17. The method of claim 16, wherein said link comprises a USB port and USB cable.

18. The method of claim 16, further comprising:
assigning predefined bonus points for events attended by a user;
tallying bonus points; and
providing a user with a prize when said bonus points reach a threshold level.

19. The method of claim 16, further comprising:
sending a receipt signal to said user indicating that a. communication intended for said user has been received.

20. The method of claim 16, further comprising:
sending a receipt signal to said user indicating that a communication intended for said user has been received; and
in response to said receipt signal, generating a user perceivable signal by a portable light emission device coupled to said computer.
